(19) United States
(12) Patent Application Publication
(10) Pub. No.: US 2013/0232161 A1
(43) Pub. Date: Sep. 5, 2013

(54) Method and Apparatus of User Recognition and Information Distribution

(71) Applicant: ALIBABA GROUP HOLDING LIMITED, Grand Cayman (KY)

(72) Inventor: Keping Yang, Hangzhou (CN)

(73) Assignee: Alibaba Group Holding Limited, Grand Cayman (KY)

(21) Appl. No.: 13/779,446

(22) Filed: Feb. 27, 2013

(30) Foreign Application Priority Data
Mar. 2, 2012 (CN) 201210052802.8

(51) Int. Cl. G06F 17/30

(52) U.S. Cl. CPC G06F 17/30386
USPC 707/758

(57) ABSTRACT

Techniques for user recognition and information distribution are described herein. These techniques may include obtaining, by a server, multiple records including a cookie in a predetermined time period. From the multiple records, the server retrieves one or more pieces of information (e.g., usernames), and individual pieces of information correspond to individual multiple records. The server may then identifying a record of the multiple records that has a username, and associate the record with a user identifier (ID) corresponding to the username. The multiple records may also include records that do not have corresponding usernames. The server may determine user IDs for these records based on the cookie and the previously determined username.

### CROSS REFERENCE TO RELATED PATENT APPLICATIONS

This application claims priority to Chinese Patent Application No. 201210052802.8, filed on Mar. 2, 2012, entitled “Method and Apparatus for User Recognition and Information Distribution,” which is hereby incorporated by reference in its entirety.

### TECHNICAL FIELD

This disclosure relates to computer and internet technologies. More specifically, the disclosure relates to methods and apparatuses for user recognition and information distribution.

### BACKGROUND

A service provider usually identifies users based on their online activities, and then provides tailored services to the identified users, thus improving service quality and reducing overhead of hardware. Information related to user online activities can include cookie information and login information. It's difficult for the service provider to use the cookie information to identify users since the cookie information has a life cycle and varies with different browsers and Internet Protocol (IP) addresses.

However, if login information (e.g., a username) is used to identify a user, the service provider may not be able to record user online activities when the user is in a non-login state. Thus, using conventional technologies, the service provider cannot accurately identify users based on their online activities. This presents a problem for the service provider, for example reducing quality and efficiency of its services, increasing overhead of its hardware, and lowering user experience.

### SUMMARY

Described herein are techniques for user recognition and information distribution. The techniques include obtaining, by a server, multiple records each including a cookie in a predetermined time period. From the multiple records, the server retrieves one or more pieces of information (e.g., username), and individual pieces of information correspond to individual multiple records. The server may then identifying a record of the multiple records that has a username, and associate the record with a user identifier (ID) corresponding to the username. The server may then identify other records that do not have corresponding usernames. The server may determine user IDs for these records based on the cookie and the previously determined username.

This Summary is not intended to identify all key features or essential features of the claimed subject matter, nor is it intended to be used alone as an aid in determining the scope of the claimed subject matter.

### BRIEF DESCRIPTION OF THE DRAWINGS

The Detailed Description is described with reference to the accompanying figures. The use of the same reference numbers in different figures indicates similar or identical items.

FIG. 1 illustrates an example architecture that includes server(s) for determining user identifiers (IDs) from user activities.

FIG. 2 illustrates an example process for associating user IDs with user activities.

FIG. 3 illustrates an example process for distributing information based on correspondences between user IDs and user activities.

FIG. 4 illustrates an example server that may be deployed in the architecture of FIG. 1

### DETAILED DESCRIPTION

The discussion below describes specific exemplary embodiments of the present disclosure. The exemplary embodiments described here are for exemplary purposes only, and are not intended to limit the present disclosure.

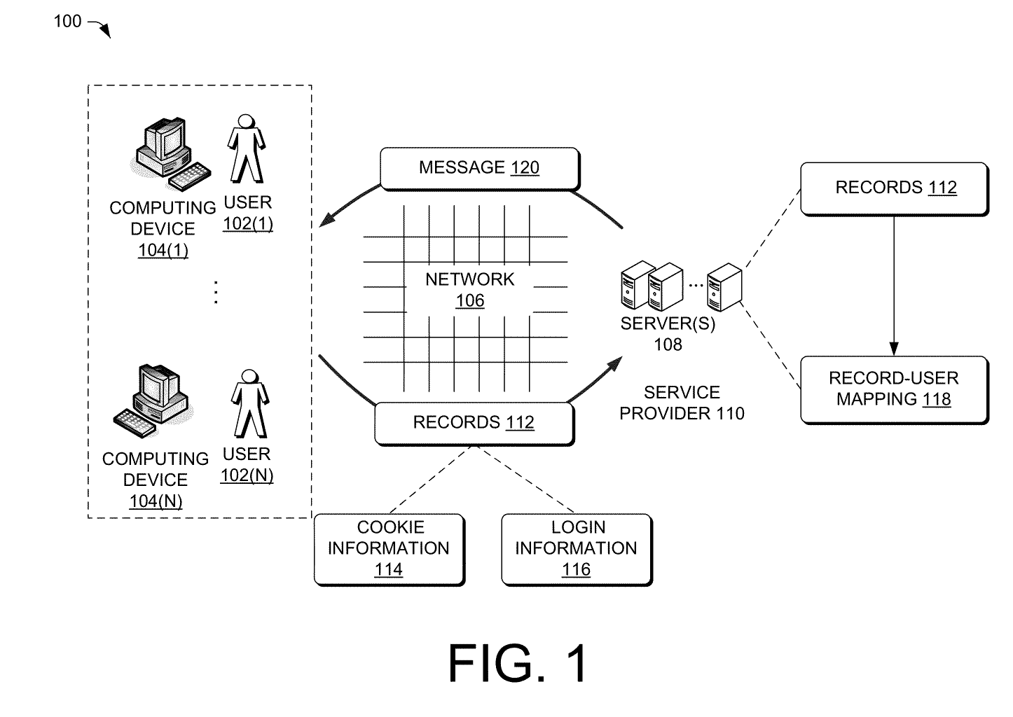

FIG. 1 illustrates an example architecture 100 that includes server(s) for determining user identifiers (IDs) from user activities. The server generates or obtains user records including user online activities and associated information. The associated information may include any information related to the user online activities. For example, the associated information may include usernames and authentication information. As used herein, the term “username” refers to an online user identifier associated with an account of an online service, or associated with certain online user activities. Examples of usernames include a login name, a screen name, a nickname, a handle and a user activity pattern that can be used to identify a certain user.

In some embodiments, the server analyzes the user records to determine user identifiers (ID) corresponding to the user records, and then associates the user IDs with the user records to generate correspondences. Based on the correspondences, the server may distribute a message to a particular user ID, and the message is tailored based on a particular user record corresponding to the particular user ID. As used herein, the term “user ID” refers to an ID that is assigned to a user and associated with an online service. In some instances, the user ID may be unique with respect to the online service. For example, a service provider may assign a user ID to a particular user based on his/her physical address and/or an official documents (e.g., driver licenses) issued by a government for the particular user.

In the illustrated embodiment, the techniques are described in the context of users 102(1), . . . , (N) operating computing devices 104(1), . . . , (N) to access various online services over a network 106. For example, the user 102(1) may operate computing device 104(1) to access online services hosted by a server 108 associated with a service provider 110. The service provider 110 may collects user activities and information associated with the user 102(1), which are recorded in record(s) 112. For example, the records 112 may include cookie information 114 and login information 116 that are associated with the user 102(1).

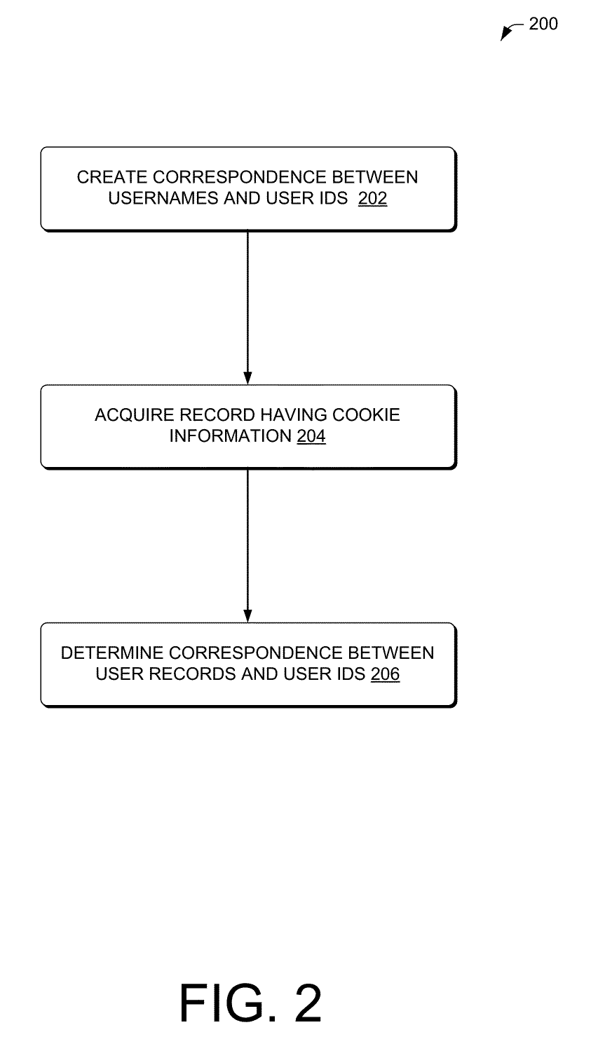

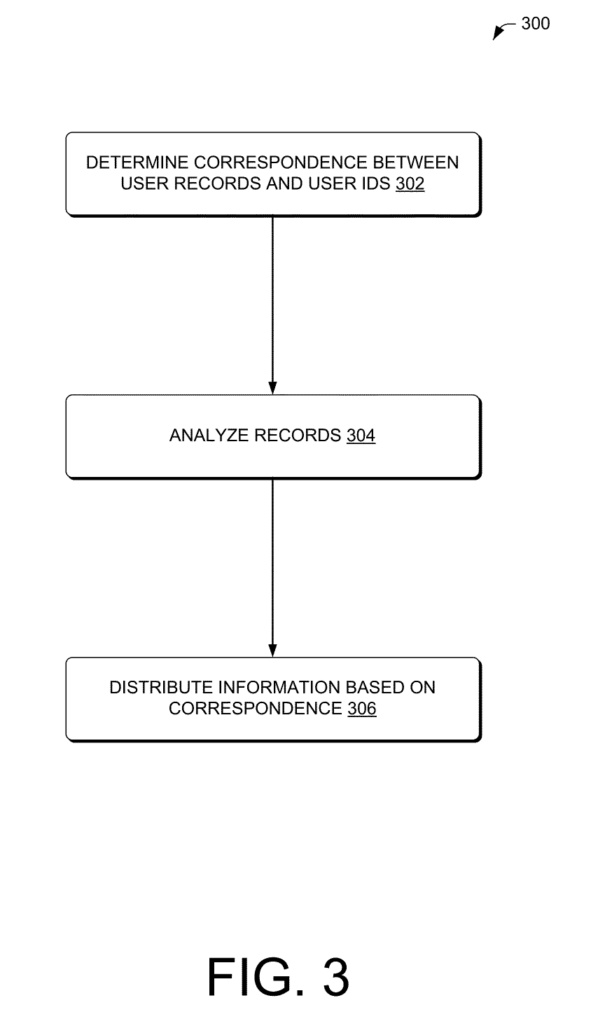

The server 108 may analyze the records 112 to determine a user ID corresponding to a record of the records 112, and associate the user ID with the record, which is discussed in greater detail in FIG. 2. In some instances, the server may generate a record-user mapping 118 that associates the individual records 112 with corresponding user IDs. Using the record-user mapping 118, the server 108 may distribute a message 120 to the user 102(1), which is discussed in greater detail in FIG. 3. The message 120 may be generated and/or tailored based on a record of the records 112 that corresponds to a user ID of the user 102(1).

Here, the network 106 may include any one or combination of multiple different types of networks, such as cable networks, the internet, and wireless networks. The computing device 104, meanwhile, may be implemented as any number of computing devices, including as a personal computer, a laptop computer, a portable digital assistant (PDA), a mobile phone, a set-top box, a game console, a personal media player (PMP), and so forth. The computing device 104 is equipped with one or more processors and memory to store applications and data.

In some embodiments, the server 108 may obtain multiple records associated with the user 102(1), . . . , (N) in a predetermined time period. The multiple records may include cookie information and login information associated with the user 102(1), . . . , (N). In some instances, individual multiple records may include the cookie information 114 and the login information 116. In certain embodiments, each record of multiple records includes a cookie containing the cookie information 114.

In some embodiments, the server 108 may retrieve one or more usernames from the multiple records. In these instances, individual usernames correspond to a record of the multiple records. Then, the server 108 may identify a first record of the multiple records that has a corresponding username. Based on previously established correspondences between user IDs and usernames, the server may determine a first user ID associated with the corresponding username.

In these embodiments, the server 108 may identify a second record of the multiple records that does not have a username. Then, the server 108 may determine a second user ID for the second record based on an acquiring time of the cookie and a login time of the corresponding username that is previously determined and associated with the first record.

In some embodiments, the server 108 may associate the first user ID and the second user ID with the first record and the second record respectively to generate correspondences such as the record-user mapping 118. In these instances, the server 108 may analyze a record of the multiple records to generate one or more notifications (e.g., the message 120), and distribute the one or more notifications to a user associated with a corresponding user ID based on the record-user mapping 118.

FIG. 2 illustrates an example process 200 for associating user IDs with user activities. The processes 200 and 300 are illustrated as collections of blocks in logical flow graphs, which represent sequences of operations that can be implemented in hardware, software, or a combination thereof. In the context of software, the blocks represent computer-executable instructions that, when executed by one or more processors, cause the one or more processors to perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the process.

At 202, the server 108 may create correspondences between usernames and user IDs. In some embodiments, to achieve aggregation on the user records, a user ID is created for identifying a user, and each user record generated by the user is determined to be corresponding to the user ID. The correspondences are represented by corresponding relationship between the usernames contained in the user records and the user IDs. Thus, data generated by the same user may be aggregated, and the aggregated user records can be used for analyzing the activities of users.

The user records may include cookie information generated when a user accesses a website. If the user is in a login state when accessing the website, the user records include not only cookie information, but also login information of the user, such as a username used when the user accesses the website. In certain embodiments, the user records can also include a login password used when the user accesses the website. If the user is in a non-login state when accessing the website, the user records include only cookie information but do not include login information such as a username and a login password. In some instances, the user records may also include an active time of the corresponding cookie information and login time of the corresponding username.

Here, when a new username is generated, a correspondence between the username and a user ID is created by analyzing the user records corresponding to the username. A user ID uniquely identifies a user, and one username corresponds to only one user ID. In some instances, a user may use multiple usernames; therefore, multiple usernames used by a user only correspond to a user ID. For example, the usernames may be registered by the same user correspond to the same user ID according to the registration information of the user.

At 204, the server 108 may acquire the user records in an identification time period that contain the same cookie information. In some embodiments, the period of the identification time period can be set manually or after a predetermined time period. For example, the identification time period may be set to be one hour, one day, etc. Accordingly, the identification for the user ID corresponding to the user records can be carried out according to the user records in one hour or one day.

At 206, the server may determine the correspondences between the user records and the user IDs according to the time information corresponding to the cookie information, the username included in the user records, the login time information of the corresponding username, and the correspondences between the usernames and the user IDs. In a certain embodiment, the server 108 may determine whether each of the acquired user records, which contain the cookie information, contain a username. Based on the determination, the subsequent process may be divided into three cases.

In the first case, if each of the user records contains a username, the correspondences between the user records and the user IDs is determined according to the correspondences between the usernames and the user IDs.

Further, if there is a user ID corresponding to the username contained in the user record, the server 108 may determine that the user ID corresponding to the username corresponds to the user records. If there is no user ID corresponding to the username contained in the user record, the server 108 may create a new user ID corresponding to the username, and then determine that the new user ID corresponds to the user records. In a certain embodiment, after creating the new user ID, the server 108 may add the correspondence between the username and the new user ID to the correspondences between usernames and user IDs that has been created.

In the second case, only a part of the user records contain a username and the rest of records do not contain a username. In this case, the user records may be divided into two parts: user record containing a username and user record not containing a username.

With respect to user record containing a username, the correspondences between the user records that contain a username and the user IDs is determined according to the correspondences between the usernames and the user IDs. Here, in processing the user records that contain a username, considering that according to the correspondences between the usernames and the user IDs that has been created, there may be a case in which there is a username having no corresponding user ID. In these instance, the subsequent processing may be carried out in accordance with the following two cases based on whether there is a user ID corresponding to the username.

If there is a user ID corresponding to the username that is contained in the user record containing a username, the server 108 may determine that the user ID corresponding to the username corresponds to the user records that contain the username. If there is no user ID corresponding to the username that is contained in the user record containing a username, the server 108 may create a new user ID corresponding to the username, and then determine that the new user ID corresponds to the user record that contains the username.

In a practical embodiment, after creating the new user ID, the server 108 may add the correspondence between the username and the new user ID to the correspondences between usernames and user IDs that has been created.

With respect to user record not containing a username, the correspondences between the user records that do not contain a username and the user IDs is determined according to the time information corresponding to the cookie information, the login time information of the usernames included in the user records, and the correspondences between the user records that contain a username and the user IDs.

In the first scenario, if all the user records, which contain usernames, correspond to a same username, different strategies may be selected according to the features of different user records generated when the user accesses different websites. For example, the strategy A (a relatively loose scheme) is a strategy in which the user records, which do not contain a username, are determined to be directly corresponding to the user ID corresponding to the user records that contain the username.

For example, the strategy B (a relatively conservative scheme) may determine the first active time t1 and the last active time t2 of the cookie information, and the first login time t3 and the last login time t4 of the username within the active time of the cookie information are acquired. Then, if the time difference between t1 and t3 is less than a preset threshold value and t2 is equal to t4, determining that the user records that do not contain a username correspond to the user ID corresponding to the user records that contain a username. If the time difference between t1 and t3 is greater than the preset threshold value or t2 is not equal to T4, determining that the user records that do not contain a username in a time period with t3 being the start time and the smaller one in t2 and t4 being the end time correspond to the user ID corresponding to the user records that contain a username.

Here, the predetermined threshold value can be set manually or can be set according to the average accessing time length of users, for example it is set to be below 15 minutes or 30 minutes.

In the second scenario, if the user records that contain a username correspond to multiple usernames. Considering the accuracy of identification results, there are two schemes: a loose scheme and a conservative scheme. For ease of description, the two schemes are referred to as strategy C and strategy D respectively in the subsequent description of the present embodiment.

For example, the strategy D (a relatively conservative scheme) is a strategy in which the user records that do not contain a username are directly discarded. The strategy C (a relatively loose scheme) is as follows. Firstly, the first active time t1 and the last active time t2 of the cookie information, and the login time of multiple usernames corresponding to the user records that contain a username within the active time of the cookie information are acquired. Then, a time period from t1 to t2 is divided into multiple sub-time periods by using the login time of multiple usernames.

In these instances, the server 108 may determine whether the user records in each sub-time period correspond to only one username. If the user records in each sub-time period correspond to only one username, the user records in a sub-time period that do not contain a username are determined to be corresponding to the user ID corresponding to the username at the starting point of the sub-time period. If the user records in each sub-time period do not correspond to only one username, the user records in the sub-time period that do not contain a username are discarded.

For example, assuming that in the user records, the first active time t1 of cookie A is 12:00 and the last active time t2 of cookie A is 15:00, the user records that contain the username in the user records correspond to three usernames (user1, user2, user3), and the login time within the active time of cookie A is respectively {user1, 12:00}, {user2, 12:30}, {user1, 13:00}, {user3, 14:00}. Therefore, according to the login time corresponding to these usernames, the active time period of cookie A is divided into {user1, [12:00, 12:30)}, {user2 [12:30, 13:00)}, {user1 [13:00, 14:00)}, {user3, [14:00, 15:00]}. The user records in the time period [12:00, 12:30) that do not contain a username are determined to be corresponding to the user ID corresponding to user1, and the user records in the time period [12:30, 13:00) that do not contain a username are determined to be corresponding to the user ID corresponding to user2, and so on. If the active time of a certain user record that does not contain a username is located on a time boundary point, the user record that does not contain a username can be allocated to the sub-time period with this time boundary point as its starting point.

In the third case, none of the user records contains a username. In this case, the server 108 may acquire the user records in a reference time period that contain the cookie information. Here, the reference time period is a period of time before or after the identification time period. For example, the reference time period can be set to 3 days before or after the identification time period or 1 week before or after the identification time period. The reference time period may be a non-continuous time period, or may be a special time period. For example, the reference time period may be set to working days in 15 days before the identification time period, or to be 12:00-20:00 in one week before the identification time period. The reference time period can be preset manually.

Then, the correspondences between the user records in the identification time period, which contain the cookie information and the user IDs, is determined according to the correspondences between the user records in the reference time period that contain the cookie information and the user IDs. In these instances, according to the difference of the correspondences between the user records in the reference time period, which contain the cookie information and the user IDs, the determination can be divided into the following conditions.

In the first condition, all the user records in the reference time period that contain the cookie information correspond to a same user ID, and the user ID is determined to be corresponding to the user records in the identification time period that contain the cookie information. That is, when the user records in the reference time period that contain the cookie information correspond to only one user ID, the cookie information in the identification time period should be considered as being generated by operations from the same user. Therefore, the user records in the identification time period that contain said cookie information are determined to be corresponding directly to the user ID.

In the second condition, the user records in the reference time period that contain the cookie information correspond to multiple user IDs, and the user records in the identification time period that contain the cookie information are discarded. The reason may be that it is unable to accurately determine that the user records that contain this cookie information but does not contain a username is generated by operation of which user, as the user records in the reference time period that contain this cookie information correspond to multiple user IDs. Therefore, for the accuracy of identification, no processing is made to the information from which accurate identification results cannot be obtained, or this information is directly discarded.

In the third condition, there is no user record in the reference time period, which contains the cookie information or there is no user ID corresponding to user records in the reference time period, which contain the cookie information, and a new user ID is created and the new user ID is determined to be corresponding to the user records in the identification time period that contain the cookie information.

In this condition, if there is no user record in the reference time period that contains the cookie information, it indicates that no user performs such a website accessing operation before. Therefore, such cookie information is a new record, and a new user ID can be created to indicate this new record.

If there are user records in the reference time period that contain said cookie information but the user records do not contain any username, it indicates that no user performs such a website accessing operation in the login state before. The newly created user ID can be used to identify a user who accesses the website in a “non-login” state, and its information is aggregated. When a “non-login” user with the same cookie information accesses the website, the “non-login” user can be identified according to the corresponding user ID.

In these embodiments, processing is made respectively for the case that all the user records in the reference time period that contain the cookie information correspond to the same user ID, the case that all the user records in the reference time period that contain the cookie information correspond to multiple user IDs, and the case that there is no user ID or there is no user record in the reference time period that contains the cookie information. The specific identifying and determining order in the various cases can be changed or adjusted as required, and the embodiments of the present application are not limited thereto.

In the identification time period, the user records corresponding to one website may include multiple different cookie information, and the user records that contain the same cookie information can are processed respectively according to the process 200 described above, thereby achieving the aggregation for all the user records.

As compared with the prior art, the embodiments of the application have the following advantages. By using the technical solution according to the embodiments of the present application, in which all the user records in the identification time period that contain the same cookie information are acquired after the correspondences between the login information and the user IDs is created, and the correspondences between the user records and the user IDs is determined according to the time information corresponding to said cookie information, the login information contained in the user records, the login time information of corresponding login information, and the correspondences between the login information and the user IDs, a method for aggregating user information is therefore provided, which can perform aggregation on user information generated when the user is in a login state and when the user is in a non-login state, thus improving the accuracy of user identification and improving the efficiency of network services, and reducing the overhead of the network-side server.

FIG. 3 illustrates an example process 300 for distributing information based on correspondences between user IDs and user activities. At 302, the server 108 may determine the correspondences between each user record in the identification time period and user IDs according to the method described in the process 200. At 304, the server 108 may analyze a user record using correspondences between the user records and the user IDs. At 306, the server 108 may distribute information to users associated with the user IDs according to the user records.

After the correspondences between the user records and the user IDs is created, the aggregation on the user information is achieved. The aggregation makes the analysis on activities of users more comprehensive and accurate. Information distribution and/or delivery with greater pertinence may be performed by determining the features of users with various analysis methods in the prior art, so as to avoid the waste of delivery resources such as servers, network bandwidth due to the incomprehensive and inaccurate analysis, and thus improve the accuracy of information delivery and improve user experience.

Hereinafter, the technical solution proposed by the embodiments of the present application will be described in combination with an embodiment. Table 1 shows the correspondences between usernames and user IDs that has been created.

TABLE 1
Correspondences between username and user ID

| Username | User ID |
|---|---|
| User1 | User ID 1 |
| User2 | User ID 2 |
| User 3 | |

Table 2 shows all the user records in the identification time period, the user records include user records that do not contain a username and user records that contain a username.

TABLE 2
User records in identification time period

| user record in | cookie information in | | |
|---|---|---|---|
| identification time period | user record | Username | Time |
| record 1 | cookie1 | User1 | 12:00 |
| record 2 | cookie1 | | 12:30 |
| record 3 | cookie2 | | 13:00 |
| record 4 | cookie2 | User1 | 13:30 |
| record 5 | cookie2 | | 14:00 |
| record 6 | cookie1 | User2 | 14:30 |
| record 7 | cookie3 | | 15:00 |
| record 8 | cookie1 | | 15:30 |
| record 9 | cookie4 | User1 | 16:00 |
| record 10 | cookie5 | User3 | 16:15 |
| record 11 | cookie1 | | 16:30 |

As illustrated by table 2, cookie1 corresponds to five user records, in which one user record corresponds to username User1, one user record corresponds to username User2, and three user records include no username. Cookie2 corresponds to three user records, in which one user record corresponds to username User1 and two user records include no username. For Cookie3, there is one user record, and no username corresponds to this user record. For Cookie4, there is one user record, which corresponds to username User1. For Cookie5, there is one user record, which corresponds to username User3.

Referring to contents in table 1, it can be known that: Username User1 has a corresponding user ID User ID1; Username User2 has a corresponding user ID User ID2; Username User3 has no corresponding user ID.

Based on the above information, according to the difference of the contained cookie information, the user identification process for the user records in the identification time period is divided into the following five cases for illustration:

In the first case, there are five user records that contain cookie1 (records 1, 2, 6, 8, and 11). Records 1 and 6 are user records that contain a username, and in the correspondences shown in table 1, each of the corresponding usernames has a corresponding user ID. Therefore, record 1 is determined to be corresponding directly to user ID User ID1 corresponding to User1, and record 6 is determined to be corresponding to user ID User ID2 corresponding to User2.

For the user records that contain cookie1 but do not contain a username (records 2, 8 and 10), since the user records that contain cookie1 and a username (records 1 and 6) correspond to different usernames User1 and User2 respectively, this corresponds to the application scenario described in the second scenario in the second case described above, i.e., only a part of the user records contain a username (records 1 and 6) and the rest do not contain a username (records 2, 8, and 10), and the user records that contain a username corresponds to multiple usernames (User1 and User2). Therefore, firstly it is determined whether strategy C (a relatively loose scheme) or strategy D (a relatively conservative scheme) is used, the specific determination rules can be set according to actual needs. Such changes do not affect the scope of protection of the present application.

If strategy D is used, records 2, 8 and 10 are directly discarded. If strategy C is used, the specific processing is as follows.

Firstly, the first active time t1 and the last active time t2 of cookie1 are acquired, which are 12:00 and 16:30, respectively. Also, the login time of multiple usernames (User1 and User2) corresponding to the user records that contain a username (records 1 and 6) in the active time of cookie1 is acquired, where the login time of User1 are 12:00, 13:30, 16:00 respectively and the login time of User2 is 14:30.

Based on the acquired time information described above, the active period 12:00 to 16:30 of cookie1 is divided into three time periods T1: (User1, 12:00-14:30), T2: (User2, 14:30-16:00), and T3: (User1, 16:00-16:30) by the login time of User1 and User2, where T1 and T3 correspond to the username User1, and T2 corresponds to the username User2.

It should be noted that since there is no other username for login during the login time of User1 between 12:00 and 13:30, the time periods corresponding to the two login time are directly linked together, i.e. T1.

After completion of the time period division mentioned above, the user records in three time periods T1, T2 and T3 that contain cookie1 but do not contain a username are determined to be corresponding to the user IDs corresponding to User1, User2, User1. That is, record 2 (in a time period T1) corresponds to user ID User ID1 corresponding to User1, record 8 (in a time period T2) corresponds to user ID User ID2 corresponding to User2, and record 10 (in a time period T1) corresponds to user ID User ID1 corresponding to User1.

In the second case, there are three user records that contain cookie2 (records 3, 4, 5). Record 4 is the user record that contains a username (User1), and in the correspondences shown in Table 1, each of the corresponding usernames has a corresponding user ID. Therefore, record 4 is determined to be corresponding directly to user ID User ID1 corresponding to User1.

For the user records that contain cookie2 but do not contain a username (records 3 and 5), since the user records that contain cookie2 and a username correspond to only one username User1, this corresponds to the application scenario described in the first scenario in the second case described above, i.e., only a part of the user records contain a username (records 4) and the rest do not contain a username (records 3 and 5), and the user records that contain a username correspond to only one username (User1). Therefore, firstly it is determined whether strategy A (a relatively loose scheme) or strategy B (a relatively conservative scheme) is used, the specific determination rules can be set according to actual needs. Such change does not affect the protection scope of the present application.

If strategy A is used, records 4 and 5 directly correspond to user ID User ID1 corresponding to User1. If strategy B is used, the specific processing is as follows.

Firstly, the first active time t1 and the last active time t2 of cookie2 are acquired, which are 13:00 and 14:00, respectively. Also, the first login time t3 and the last login time t4 of the user1 in the active time of cookie2 are acquired. Since there is only one login event for User1 during this period, the first login time t3 and the last login time t4 both are 13:30.

Assuming that the preset threshold delta is 1 hour, then −t3−t1|=0.5 hour<delta, and t2 is not equal to t4, i.e., the end time is different. In this case, only the user records in the time period t3 (t2, t4), i.e., 13:30˜13:30 can be determined to be corresponding to the user ID corresponding to User1. Therefore, no processing is made to record 3 and record 5, or record 3 and record 5 are discarded directly.

In the third case, there is one user record that contains cookie3 (record 7). None of the user records that contain cookie3 in the identification time period contain a username, which corresponds to the third case described above. Therefore, it is needed to acquire the user records in the reference time period that contain cookie3, and the corresponding process is performed according to the correspondences between user records and user IDs, specifically:

If the user records in the reference time period that contain cookie3 correspond to only one user ID (assuming that it is User ID1), it is considered that cookie3 in the identification time period should also be generated by the operation from the same user. Therefore, record 7 corresponds directly to the user ID User ID1. Of course, in the conservative case, it is also possible that no processing is made to record 7.

If the user records in the reference time period that contain cookie3 correspond to multiple user IDs, then record 7 is discarded directly. If there is no user record that contains cookie3 in the reference time period, or the user records in the reference time period that contain cookie3 correspond to none of user IDs, then a new user ID (e.g. User ID3) is created, and record 7 corresponds to the user ID User ID3.

In the fourth case, there is one user record that contains cookie4 (record 9). Record 9 includes cookie4 and a username User1, which corresponds to the first case described above. Since according to the correspondences shown in Table 1, User1 corresponds to User ID1, so record 9 corresponds directly to the user ID User ID1 corresponding to User1.

In the fifth case, there is one user record that contains cookie5 (record 10). Record 10 includes cookie5 and a username User3, which corresponds to the first case described above. Since according to the correspondences shown in Table 1, User3 has no corresponding User ID, so a new user ID corresponding to User3 is created, such as User ID4, and it is determined that the new user ID User ID4 corresponds to record 10.

In a practical embodiment, after the new user ID (User ID4) is created, it is also needed to add the correspondences between the username User3 and the new user ID User ID4 to the correspondences between usernames and user IDs that has been created (i.e., table 1).

As compared with the prior art, the embodiments of the application has the following advantages. By using the technical solution according to the embodiments of the present application, in which all the user records in the identification time period that contain the same cookie information are acquired after the correspondence between the login information and the user IDs is created, and the correspondences between the user records and the user IDs is determined according to the time information corresponding to said cookie information, the login information contained in the user records, the login time information of corresponding login information, and the correspondences between the login information and the user IDs, a method for aggregating user information and a method for information delivery are therefore provided, which can perform aggregation on user information generated when the user is in a login state and when the user is in a non-login state, thus improving the accuracy of user identification and improving the efficiency of network services, as well as reducing the overhead of the network-side server.

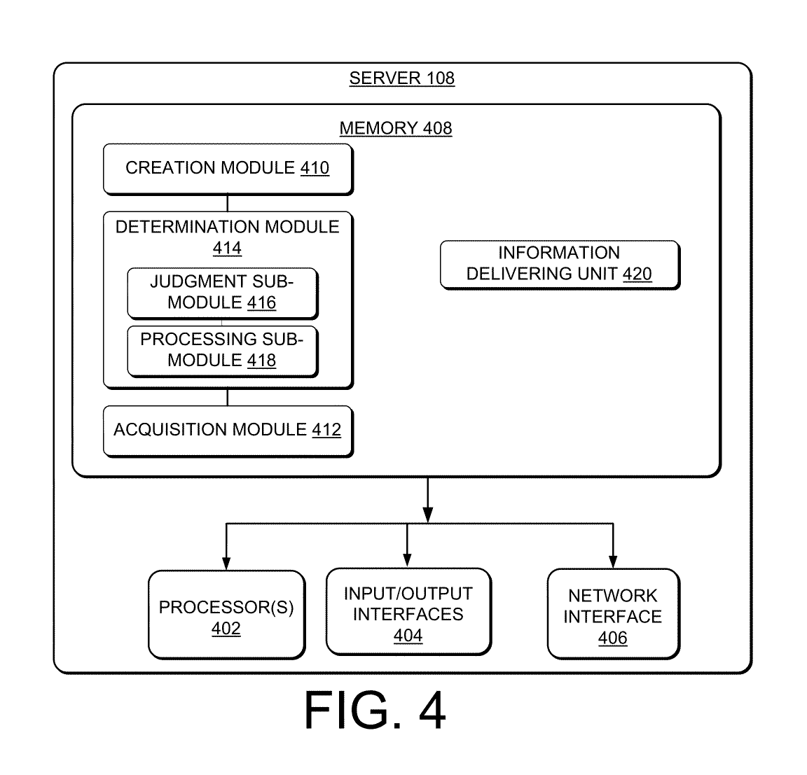

FIG. 4 illustrates an example server 108 that may be deployed in the architecture of FIG. 1. The server 108 may be configured as any suitable computing device(s). In one exemplary configuration, the server 108 includes one or more processors 402, input/output interfaces 404, network interface 406, and memory 408.

The memory 408 may include computer-readable media in the form of volatile memory, such as random-access memory (RAM) and/or non-volatile memory, such as read only memory (ROM) or flash RAM. The memory 408 is an example of computer-readable media.

Computer-readable media includes volatile and non-volatile, removable and non-removable media implemented in any method or technology for storage of information such as computer readable instructions, data structures, program modules, or other data. Examples of computer storage media include, but are not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device. As defined herein, computer-readable media does not include transitory media such as modulated data signals and carrier waves.

Turning to the memory 408 in more detail, the memory 408 may include a creation module 410, an acquisition module 412, and a determination module 414

The creation module 410 is configured to create correspondences between login information and user identifiers, wherein one piece of login information corresponds to one user identifier, and one user identifier corresponds to one or more pieces of login information.

In some embodiments, the creation module 410 creates a user identifier for identifying a user, and the user records generated by each user are determined to be corresponding to the user identifier, the correspondences are represented by the corresponding relationship between the usernames contained in the user records and the user identifiers. Thus, data generated by a user is aggregated, and the aggregated user records can be used for analyzing user activities.

The acquisition module 412 is configured to acquire or obtain user records in the identification time period that contain the same cookie information. Wherein, the size of the identification time period can be set experientially or can be set to be a predetermined time length.

The determination module 414 is configured to determine the correspondences between the user records and the user identifiers according to the login information included in the user records that is acquired by the acquisition module 412, the login time information of corresponding login information, the time information corresponding to the cookie information, and the correspondences between the login information and the user identifiers that is created by the creation module 410.

In a practical embodiment, the determining module 414 includes a judgment sub-module 416 and a processing sub-module 418. The judgment sub-module 416 is configured to determine whether all the acquired user records that contain the cookie information contain a username. The processing sub-module 418 is configured to perform subsequent processing according to the determination results from the judgment sub-module 416.

If the judgment sub-module 416 determines that all user records contain a username, the processing sub-module 418 determines the correspondences between the user records and user identifiers according to the solution described in the first case in the aforementioned process 200.

If the judgment sub-module 416 determines that only a part of the user records contain a username and the rest do not contain a username, the processing sub-module 418 determines the correspondences between the user records and user identifiers according to the solution described in the second case in the aforementioned process 200.

If the judgment sub-module 416 determines that none of the user records contain a username, the processing sub-module 418 determines the correspondences between the user records and user identifiers according to the solution described in the third case in the aforementioned process 200.

In some embodiments, the memory 408 may also include an information delivery unit 420 configured to distribute information to users corresponding to user identifiers according to the user records corresponding to the user identifiers. In other embodiments, the information delivery unit 420 may be implemented by a server different from the server 108.

By using the technical solution according to the embodiments of the present application, in which all the user records in the identification time period that contain the same cookie information are acquired after the correspondence between the login information and the user identifiers is created, and the correspondences between the user records and the user identifiers is determined according to the time information corresponding to said cookie information, the login information contained in the user records, the login time information of corresponding login information, and the correspondences between the login information and the user identifiers, a method for aggregating user information and a method for information delivery are therefore provided, which can perform aggregation on user information generated when the user is in a login state and when the user is in a non-login state, thus improving the accuracy of user identification and improving the efficiency of online services, as well as reducing the overhead of hardware such as the server 108.

Those skilled in the art can understand that the modules in the apparatus can be distributed in the apparatus in the embodiments as described in the embodiments, and can also be positioned in one or more apparatuses different from the apparatus in the embodiments. The modules of the above embodiments can be combined into one module, and can also be split into multiple sub-modules.

Through the above description of the embodiments, those skilled in the art can clearly understand that the present application can be implemented by means of software plus a necessary universal hardware platform, and can also be implemented by hardware, but in many cases the former is a preferable embodiment. Based on such understanding, the technical solution of the present application or the part that contributes to the prior art can be substantially embodied in a form of software product. The computer software product is stored in a storage medium and includes several instructions that can make a terminal equipment (that may be a mobile phone, a personal computer, a server, or a network equipment, etc.) perform the method of the embodiments of the present application.

The embodiments described above are only preferred embodiments of the present application. It should be noted that numerous improvements and modifications can be made by those skilled in the present art without departing from the principles of the present application, and these improvements and modifications should be deemed as falling within the scope of protection of the present application.

What is claimed is:

1. One or more computer-readable media storing computer-executable instructions that, when executed by one or more processors, instruct the one or more processors to perform acts comprising:
obtaining multiple records including a cookie in a predetermined time period;
retrieving one or more usernames from the multiple records, individual username of the one or more usernames corresponding to individual record of the multiple records;
identifying a first record of the multiple records that has a corresponding username of the one or more usernames;
determining a first user identifier (ID) associated with the corresponding username;
identifying a second record of the multiple record that does not have a username; and
determining a second user ID for the second record based on the cookie and the corresponding username.

2. The one or more computer-readable media of claim 1, wherein the multiple records include cookie information and login information that are associated with one or more user IDs, and the individual record of the multiple records include the cookie.

3. The one or more computer-readable media of claim 1, wherein the determining the second user ID for the second record based on the cookie and the corresponding username comprises determining the second user ID for the second record based on an acquiring time of the cookie and a login time of the corresponding username.

4. The one or more computer-readable media of claim 1, wherein the acts further comprise:
associating the first user ID and the second user ID with the first record and the second record respectively to generate a record-user mapping.

5. The one or more computer-readable media of claim 4, wherein the acts further comprise:
analyzing the first record and the second record to generate one or more notifications; and
distributing the one or more notifications based on the record-user mapping.

6. The one or more computer-readable media of claim 1, wherein the determining the first user ID associated with the corresponding username comprises determining the first user ID associated with the corresponding username based on a predetermined relationship between user IDs and usernames.

7. The one or more computer-readable media of claim 1, wherein the acts further comprise obtaining additional multiple records including an additional cookie in a predetermined time period, and wherein the additional multiple records do not include a username of the one or more usernames.

8. The one or more computer-readable media of claim 7, wherein the acts further comprise discarding the additional multiple record.

9. The one or more computer-readable media of claim 1, wherein the acts further comprises:
identifying a third record of the multiple records that has one corresponding username of the one or more usernames;
determining that the one corresponding username does not have a corresponding user ID based on a predetermined relationship between user IDs and usernames; and
generating a user ID for the third record.

10. A computer-implemented method comprising:
retrieving one or more pieces of login information from multiple records, individual piece of the one or more pieces of login information corresponding to individual record of the multiple records, and the individual record including a cookie;
identifying a record of the multiple records that has a corresponding piece of login information of the one or more pieces of login information;
determining a user identifier (ID) associated with the corresponding piece of login information;
identifying an additional record of the multiple records that does not have a piece of login information of the one or more pieces of login information; and
determining a user IDs for the additional record based on the cookie and the corresponding piece of login information.

11. The computer-implemented method of claim 10, wherein the determining the user ID for the additional record based on the cookie and the corresponding piece of login information comprises determining the user ID for the additional record based on an acquiring time of the cookie and a login time associated with the corresponding piece of login information.

12. The computer-implemented method of claim 10, further comprising:
associating the user ID for the additional record with the additional record to generate a record-user mapping.

13. The computer-implemented method of claim 10, further comprising:
analyzing the additional record to generate information; and
distributing the information to the user ID for the additional record.

14. The computer-implemented method of claim 10, wherein the determining the user ID associated with the corresponding piece of login information comprises determining the user ID associated with the corresponding username based on a predetermined relationship between the user ID and the corresponding piece of login information.

15. The computer-implemented method of claim 10, wherein the determining the user ID associated with the corresponding username comprises:
determining that the corresponding piece of login information does not have a corresponding user ID based on a predetermined relationship between multiple user IDs and login information; and
generating a user ID for the record.

16. A computing device comprising:
one or more processors; and
memory to maintain a plurality of components executable by the one or more processors, the plurality of components comprising:
an acquisition module that obtains multiple records in a predetermined time period, individual username of the one or more usernames corresponding to individual record of the multiple records, and the individual record including a cookie, and
a determination module that:
identifies a first record of the multiple records that has a corresponding username of the one or more usernames,
determines a first user identifier (ID) associated with the corresponding username,
identifies a second record of the multiple record that does not have the corresponding username, and
determines a second user ID for the second record based on the cookie and the corresponding username.

17. The computing device of claim 16, wherein the determining the second user ID for the second record based on the cookie and the corresponding username comprises determining the second user ID for the second record based on an acquiring time of the cookie and a login time of the corresponding username.

18. The computing device of claim 16, wherein the determining the first user ID associated with the corresponding username comprises determining the first user ID associated with the corresponding username based on a predetermined relationship between the user IDs and usernames.

19. The computing device of claim 16, wherein the computing device further comprises an information delivery module that:
analyzes the second record to generate a message; and
distributes the message to the second user ID.

20. The computing device of claim 16, wherein the determination module further:
identifies a third record of the multiple records that has one corresponding username of the one or more usernames;
determines that the one corresponding username does not have a corresponding user ID based on a predetermined relationship between user IDs and usernames; and
generates a user ID for the third record.
